(19) United States
(12) Patent Application Publication
(10) Pub. No.: US 2003/0217059 A1
(43) Pub. Date: Nov. 20, 2003

(54) System and method for internet search engine

(75) Inventors: Arthur L. Allen, Naples, FL (US); Carl Thomas Andrews, Naples, FL (US); Kyle Owen Peterson, Calgary (CA); Keith J. Richardson, Sanibel Island, FL (US)

Correspondence Address: Stuart T. F. Huang, Steptoe & Johnson, 1330 Connecticut Avenue, N.W., Box PTO, Washington, DC, 20036, US

(73) Assignee: ASG, Inc., Naples, FL

(21) Appl. No.: 10/146,482

(22) Filed: May 16, 2002

(51) Int. Cl. G06F 17/30

(52) U.S. Cl. 707/10

(57) ABSTRACT

An Internet search engine is disclosed. The search engine is capable of producing relevant search results in a ranked order, which is at least partially determined by the web site providers themselves. The search engine is preferably fee-based and policed to provide relevant search results to the end user.

### BACKGROUND OF THE INVENTION

1. Field of the Invention

The present invention is directed to an Internet search engine. More specifically, the present invention is directed to an Internet search engine that produces robust search results.

2. Discussion of Background Information

Internet search engines receive one or more search terms (“search criteria”) from a user to search the World Wide Web for web pages that meet the search criteria. Such a search more typically occurs on a preexisting index of web page contents, wherein associations between a search criteria and entries in the index will identify a particular web page as relevant to the search criteria.

There are several known methods to generate the index. The most common is known as “crawling.” This is an automatic method that repeatedly searches all available web sites. Each web site includes one or more web pages. Starting with a first web page on the site, the program notes prominent terms as relevant (e.g., words in the title, first paragraph, etc.), such that the web page will be associated with that term in the index. The program then follows links in the web page to other web pages on the site, thereby “crawling” about various web pages within the web site.

A drawback of the above indexing methodology is that the automatic program will only “crawl” to a certain depth in the web site. For large web sites with an extensive number of web pages, the crawling program will not review or scan a majority of the web pages. In addition, web site providers do not have any say or input into what index terms will be selected, or the specific web pages with which these index terms will be associated.

Another drawback of the above indexing methodology is that the ranking of the search results is based on the indexing program independently determining the relevance of the web page to search criteria. Specifically, the results of a search are “ranked” in that they will be listed in some order (i.e., the highest ranked entry is listed first, etc.). Every web site provider wants a high ranking to improve the probability that the user will click to their web site. Web site designers therefore attempt to design web sites to place specific terms in the introductory elements of the web page such that they will be favorably recognized by the automatic crawling program. However, because the introductory material is also the first thing seen by the user, the presence of the specific terms may not be preferable with respect to the presentation of the material on the web page.

Yet another drawback from the above indexing scheme is that designers often use meta-tags or add spam (sometimes known as “spamdexing”) to create improper indexing or improve rank. An example of such abuse would be a pornographic website entering a meta-tag for a famous person, such that a search for that famous person would identify the pornographic site as relevant. Indexing programs only have limited effectiveness in screening out such abuse.

As a result of these drawbacks, simple searches can often result in thousands of “hits,” the overwhelming majority of which are irrelevant. Further, because the association between the search terms and the web pages is not selected by the web site providers, there is no guarantee that the web site provider's preferred web pages will either appear in the search results or have a favorable ranking.

Another prior art indexing scheme is based on human interaction. In this scheme, the web site provider prepares a short written summary of the contents of the web site. Human editors at the search engine provider review the summary and determine appropriate search criteria to link to that web site. The web site provider still does not have control over the association between the selected search terms and associated web pages and cannot control the rank in which they appear.

A newer search methodology is based on the search engine providers auctioning particular search criteria. The web site provider with the highest bid for the search criteria will appear first in rank for a corresponding search for that search criteria. The web site provider with the second highest bid will appear second, etc. The “bid” is for the amount that the web service provider will pay the search engine provider every time a user clicks on a web site that is listed in this search. Payments of $3 per click are not uncommon and can be extremely expensive over time.

Specialized fee-oriented search engines are known. These search engines are typically devoted to a specific topic or class of web pages and will otherwise only return web pages that are both registered with the search engine and consistent with the dedicated topic of the search engine. These search engines may also contain indexes of the subject matter of the web sites, but the indexes are not expandable to the needs of the customer.

### SUMMARY OF THE INVENTION

The present invention provides a general-topic search engine that preferably is fee based and policed to provide relevant search results. The present invention also allows greater web site provider participation in the indexing process.

According to a preferred embodiment of the present invention, a method for associating a web site provider with a search engine provider is provided. The web site provider maintains a web site containing a plurality of web pages and the search engine provider maintains a master index for use with a search engine for Internet searching. A search criteria is associated with a subset of web pages from the plurality of web pages. The web provider ranks each web page of the subset of web pages. The search engine provider's master index is modified to reflect the search criteria and the association with the subset of web pages. A search report from a search on the search engine using the search criteria will include the subset of web pages in an order consistent with the rank determined by the web site provider.

Various optional and preferable features of the above embodiment include that the web service provider selects the subset of web pages from the plurality of web pages, where the search report will not include any of the plurality of web pages that are not in the subset of web pages. The search criteria is received, the master index is searched based on the search criteria, and the search report is provided based on the searching. The search report includes the subset of web pages consistent with the rank. Additionally, the search report may be provided consistent with displaying the subset of web pages as a block within the search report, displaying the subset of web pages at least partially interleaved with other web pages that are also associated with the search criteria, or displaying the subset of web pages completely interleaved with other web pages that are also associated with the search criteria. The search engine may be an external search engine.

According to another preferred embodiment of the invention, a method for associating a web site provider with a search engine provider is provided. The search engine provider maintains a master index for use with a search engine for Internet searching. A web site it automatically searched, under computer control, for terms of interest to add to a temporary index. The contents of the temporary index are used to identify a desired search criteria. This usage may be consistent with selecting at least part of the temporary index, rejecting the temporary index, or adding at least one new term to the temporary index. The web page is associated with the desired search criteria. The search engine provider's master index is modified to reflect the results of the associating. And the searching is improved by limiting the master index to relevant search criteria.

Various optional and preferable features of the above embodiment include that the automatic searching is consistent with searching for meta-tags in the web site and words or combinations of words that tend to repeat with a higher frequency than other words or combinations of words in the web site. The associating may include testing the master index with the search criteria. The use of the temporary contents may include manually using. The manual usage may be by the web site provider. The temporary index may be modified consistent with selecting all of the terms of interest as search criteria, selecting at least some of the terms of interest as search criteria, or adding at least one new term that did not result from the automatically searching. Alternately, the associating may include associating a plurality of web pages with the search criteria. A web site provider determines the order in which a plurality of web pages will appear in a search report in response to a search on the search engine using the search criteria. And the search report will include the plurality of web pages in the order determined by the web site provider. The search engine may be an external search engine.

According to another preferred embodiment of the invention, a method for establishing and operating a search engine for Internet searching a plurality of web sites is provided. A search engine provider works with a web site provider of each of a plurality of web sites to mutually decide on a search criteria that will produce a search report that includes at least one web page from the web site and modify a master search index to reflect an association between the search criteria and the at least one web page. In response to a particular search criteria input to the search engine, all of the associated web pages reflected in the master index associated with the search criteria are provided. An order in which the associated web pages appear in the search report is independent of any fees paid by the web service providers.

Various optional and preferable features of the above embodiment include that the order in which the associated web pages from the master index appear in the search report is independent of the content of the associated web pages. Alternately, the order in which the associated web pages from the master index appear in the search report is one of random and pseudo-random. A global search report is produced, the global search report including the results of the providing and at least one of the results of an auction-based search and the results of a crawling-based search. The search engine may be an external search engine.

According to another preferred embodiment of the invention, a method for associating a web site provider with a search engine provider is provided. The web site provider maintains a web site containing a plurality of web pages and the search engine provider maintains a master index for use with a search engine for Internet searching. At least one web page on the web site is associated with a search criteria. The master index is test searched with the search criteria. The web site provider determines, based on a result of the test searching, whether the search criteria is one of acceptable and too broad for the at least one web page. In response to a determination that the search criteria is too broad, a different search criteria is selected, where the different search criteria is associated with fewer search results relative to the number of search results associated with the search criteria.

Various optional and preferable features of the above embodiment include that the test searching, the determining, and the modifying are repeated until the determining determines that the search criteria is acceptable. Between the associating and the test searching, a search engine provider's master index is temporarily altered to reflect the association between the search criteria and the web page. Between the associating and the test searching, a search engine provider's master index may be temporarily altered, contingent upon a condition, to reflect the association between the search criteria and the at least one web page. The condition may be whether the number of web pages associated with the search criteria is below a predetermined threshold. In response to the determining being acceptable, a search engine provider's master index may be modified to reflect the association between the search criteria and the at least one web page. A web provider may pay a fee to the search engine provider in exchange for the modifying. Prior to the determining, a search engine provider's master index may be modified to reflect the association between the search criteria and the at least one web page.

According to another preferred embodiment of the invention, a method for associating a web site provider with a search engine provider is provided. The web site provider maintains a web site containing a plurality of web pages, and the search engine provider maintains a master index for use with a search engine for Internet searching. At least one web page on the web site is associated with a search criteria. The master index is test searched with the search criteria to determine the number of associated web pages in the master index. Based at least on the number, it is determined whether the search criteria is too broad for the at least one web page. The search criteria is altered to produce an altered search criteria, where the altered search criteria has less associated web pages in the master index than the unaltered criteria.

Various optional and preferable features of the above embodiment include that the test searching, the determining, and the modifying are repeated until the determining determines that the search criteria is not too broad for the at least one web page. Between the associating and the test searching, a search engine provider's master index is temporarily altered, contingent upon a condition, to reflect the association between the search criteria and the at least one web page. The condition may be whether the number of web pages associated with the search criteria is below a predetermined threshold. If the determining determines that the search criteria is acceptable, a search engine provider's master index is altered to reflect the association between the search criteria and the at least one web page, and a web provider pays a fee to the search engine provider in exchange for the modifying. The search engine may be an external search engine.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of certain embodiments of the present invention, in which like numerals represent like elements throughout the several views of the drawings, and wherein:

FIG. 1 is a flowchart illustrating a preferred embodiment of the invention;

FIGS. 2 and 3 are flowcharts illustrating testing methodologies;

FIG. 4 illustrates the structure of the preferred embodiment; and

FIG. 5 illustrates an embodiment where an external search engine can conduct searches on the search engine provider's site.

FIG. 6 illustrates an embodiment where an external search engine can access the search engine provider's database.

### DETAILED DESCRIPTION OF THE EXEMPLARY EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The preferred embodiment of the present invention is directed to a search engine provider that works directly with web site providers to enter specific web pages into a fee-based index for use by the search engine. The search engine is preferably generic in that it is not limited to or represented as associated with a specific topic. The fee is preferably structured as a registration fee, rather than a click fee as used by auction based search engines. The fee-based system provides a first level of protection against irrelevant web sites, as the fee will exclude/deter the participation of otherwise less relevant web sites.

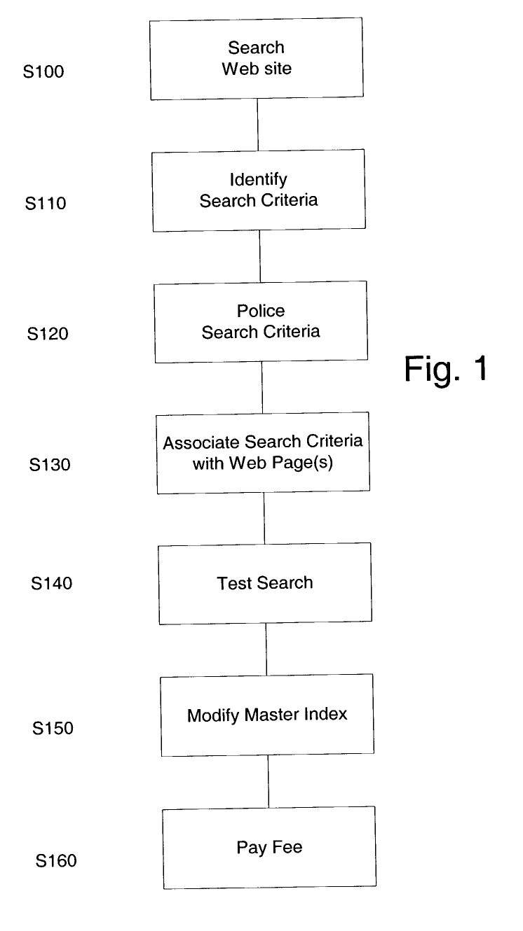

Referring now to FIG. 1, a search engine provider will work with a specific web site provider to determine appropriate search criteria for specific web pages in the web site. At a first step S100, the search engine provider searches the web site to identify relevant terms. The search methodology is similar to the known “crawling” indexing scheme, except that the probe will be focused on the web site instead of the entire Web. This index search will produce a list of terms and phrases for use as search criteria that can be associated with web pages in the web site.

The above search may be consistent with one or more rules stored in a rules database. Rules can control which parts of the site are to be indexed and how the indexing occurs. By way of non-limiting example, rules could include any of the following: pages with a URL matching a certain template are not to be indexed (e.g., URLs that start www.mysite.com/product); pages with URLs matching a template are to be given specific keywords regardless of whether the page actually uses the keyword; and pages containing a certain term are to have additional keywords added. Any rule may be used for all searches, or limited to only select searches.

Using the results of the index search as a starting point, the search engine provider works in concert with the web service provider at step S110 to identify what search criteria are appropriate for the web site as a whole, or individual web pages in the web site. The web service provider may accept the results of the index search, modify it in some way, or reject it in its entirety. In the alternative, the web provider may provide the desired search criteria without conducting an index search.

The above process provides an opportunity for the search engine provider to police the index terms that connect to the web site. For example, at step S120, the search engine provider may refuse to accept search criteria that are inappropriate or misleading for the site, as use of such terms in the indexing scheme would be contrary to providing relevant search results.

Once the appropriate search criteria are decided upon, the web site provider can determine at step S130 which specific web page(s) in the site will correspond to the search criteria. For multiple web pages, the web site provider can also determine the order in which these pages will be returned by the search. For example, a search criteria relating to a product might result in a search that first lists the introductory web page for the company, next lists the web page for the product, and finally lists a web page with consumer reviews of the product. This also inherently grants the web site provider the ability to decline associating certain web pages of the search criteria.

It is noted that the web site provider need not be limited to one set of search criteria. For example, a manufacturer may select several different search criteria, each corresponding to one or more web pages for a particular product.

Similarly, the term “search criteria” is meant to encompass a set of one or more search terms. That is, a search criteria may comprise a single term or a plurality of terms. By way of non-limiting example, a search criteria typically consists of a phrase or brief description of the desired topic to be searched for. Just as each web page may be associated with one or more search criteria, each search criteria may be associated with one or more web pages.

The above process of determining appropriate search criteria may include a test search at S140 to determine whether the selected search criteria will result in an effective search. For example, even though the web site provider selects desired search criteria, the resulting search may yield so many hits that the web site of any particular web site provider is buried. In other words, since the preferred embodiment of the invention does not pre-assign ranking to registered web sites, the resulting rank of the web page in the search could be so low as to be ignored. In such situations, it is preferable to alter the search criteria to produce a smaller search report. Such an alternation narrows the search criteria in that it typically adds terms to the criteria thereby reducing the number of web pages that satisfy the criteria. Other procedures for alteration include using modified search criteria, a superset of the original search criteria terms, or search criteria with some or no terms in common.

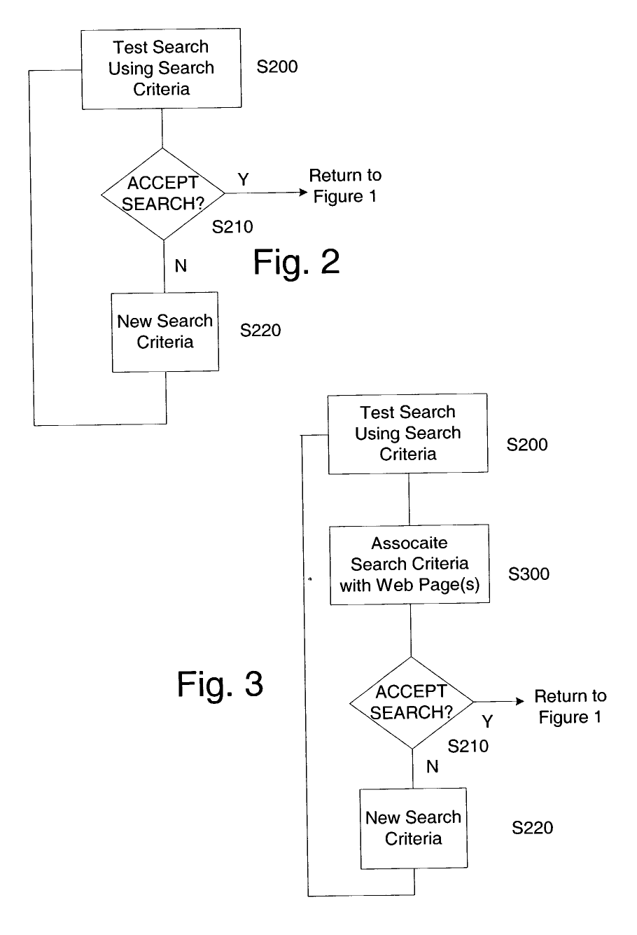

FIG. 2 shows an embodiment of a testing methodology for step S140. At step S200, a test search is conducted on the search engine provider's search engine using the selected search criteria. Based on at least the length of the resulting search report, the web site provider at step S210 can elect to accept the search criteria or narrow the search criteria. If the web site provider accepts the search criteria, then the process returns to FIG. 1. If the web site provider rejects the search criteria, then the web site provider selects a new (preferably narrower) search criteria at step S220, whereupon the process returns to step S200. This process repeats until the web site provider is satisfied that the length of the search report is of sufficient size to ensure that the web site provider's web page will either receive a favorable rank, or at least a sufficient probability of a favorable rank.

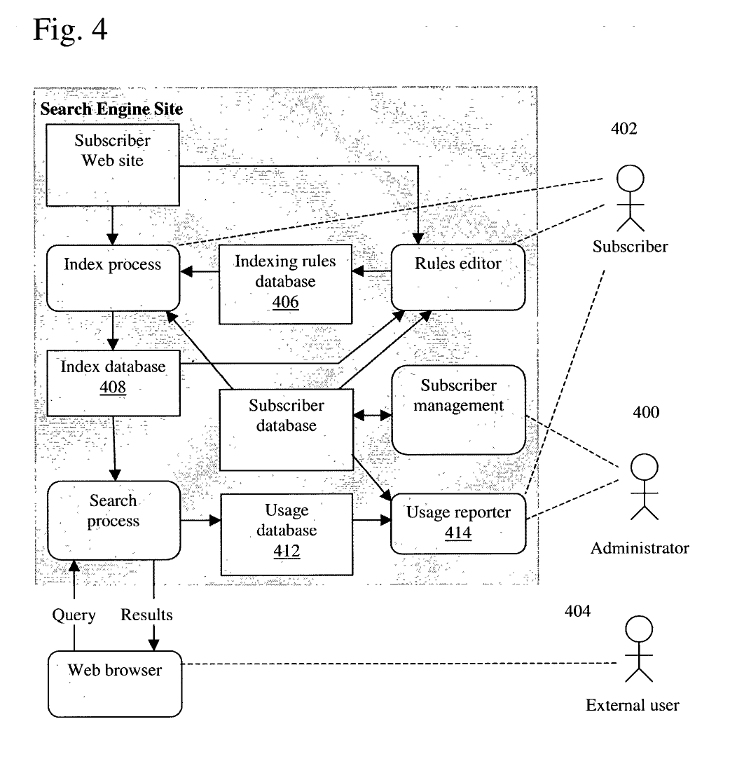

FIG. 3 shows another embodiment of the testing methodology. Similar to the embodiment of FIG. 2, this embodiment adds step S300 of the search engine provider modifying its master search index 408 (see FIG. 4) to include the association between the selected search criteria and the associated web page(s). The resulting test search at step S210 will thus include the selected web pages in the test search report. This can assist the web service provider to judge whether the selected terms are satisfactory.

Returning to FIG. 1, once the search criteria and the associated web pages are established, the search engine provider at step S150 adds the search criteria and their association with the web site provider's web pages to the existing master search index. If this has been done previously through the testing methodology of FIG. 3, then this step is little more than not removing the last modification of the master index to include the desired search criteria.

According to the testing methodology of FIG. 3, a plurality of search criteria may be associated with a single web page. The “loop” of FIG. 3 may associate several search criteria with a web page before accepting a sufficiently narrow criteria at step S210. In this manner, the web page may be associated with various broad and narrow search criteria. That is, the process of FIG. 3 may repeat several times, each time associating a different search criteria with the web page, before an acceptably narrow search criteria causes a return to the process of FIG. 1 at step S210.

Alternately, step S300 may be performed or not performed on each loop cycle contingent upon various parameters such as number of “hits.” That is, the association of the web page with a particular search criteria at step S300 may depend upon how many other pages turn up in the test search (even though the test search is not accepted at step S210). By way of non-limiting example, step S300 may associate a search criteria with the web page only if the test search reveals less than a threshold number of web pages. The threshold number of web pages is typically greater than the number that would cause the test procedure of FIG. 3 to terminate. Thus, a plurality of search criteria may be associated with the web page, each having varying degrees of breadth, without any single search criteria being associated with a greater than threshold number of other web pages.

The master search index 408 is an expandable database. If all or part of the search criteria is already present in the master index, then the association with the new web page(s) will simply be added to the same such that a search for that search criteria will produce all of the web pages that have associated web page(s). If the search criteria is not present in the master index database, then it is added thereto along with the association with the web page(s).

The master search index database 408 may be a true database, or other suitable data structure such as a linked list, arrangement of tables, tree structure, or the like. The term “database” is not meant to limit the invention to a particular data structure configuration of the master search index 408.

The above process may be repeated for different search criteria and different web pages. For example, a manufacturer might select several different search term(s), each corresponding to a different product and one or more web pages associated with that project.

Once the number of search criteria and web pages have been decided upon, the search engine provider at step S160 assesses a fee to the web service provider in exchange for adding the search criteria and web pages to master search index 408 for at least a period of time. The nature of the fees for the above embodiment may take any desired form. A single fee could be used for an entire website. In the alternative, the fee could be based on the number of search criteria or the number of pages to be returned. The invention should not be considered to be limited to any particular fee structure.

Unlike an auction-based search engine, the present invention preferably does not provide any guarantee of ranking, or otherwise associate rank with the payment of the fee. In other words, while registration with the search engine requires payment of the fee, this only guarantees that registered web pages will be included in the search report, but not where the web pages will appear in the search report. The only exception is that the web pages for a particular web service provider will appear in the order selected by the web service provider. However, this order does not guarantee any rank relative to other web pages listed in the search report. Indeed, in preserving this order, the web sites may appear in the search report as a block (all web pages appear sequentially), partially interspersed with other web pages, or completely interspersed with other web pages.

As noted above, auction based prior art search engines charge for ranking, and general search engines rely upon the content of the web sites to determine a ranking. In the preferred embodiment, a methodology is provided to give each of the web pages equal opportunity for high rankings. One such methodology is to randomize the results of the search (while maintaining each web site provider's preset order of its own web pages). Some type of pseudo-randomization, such as rotating the list or rotating through the web service provider, can also be used. In this manner, the order of the results of the search report is independent of both the content of the web pages associated with the search terms and the fee paid.

In the alternative, an auction-based ranking methodology could be used, either alone or as part of a separate set of search results.

A search report provided consistent with the present invention need not be the only such search report returned in response to search criteria. For example, prior art search engines typically provide two separate search reports—a first displayed search report with the results of an “auction-based” search as described above, followed by a general search report from the “crawling-based” search. The search report of the present invention may also be supplied along with one or more search reports from different search methodologies, or stand on its own.

In the preferred embodiment of the invention, the use of a fee-based system in which the search engine provider polices the indexing system can provide searches that do not contain the volume of irrelevant hits that result from prior art searches. In addition, consideration of the entire web site and the wishes of the web site provider in determining which web pages will be returned by a search or specific search criteria should not only increase the relevance of the search but also improve the way in which web site providers present their web pages from searches. The preferred embodiment is therefore believed to be more appealing to both the general public and the web service providers than any prior art search engine model.

The present invention is not limited to the order of the steps described in the embodiments herein. Further, the steps need not be performed completely for all possibilities. By way of non-limiting example, steps S110-S140 could be repeatedly performed for different search criteria before paying the fee in step S150. Similarly, steps S110-S140 could be repeatedly performed for different search criteria before conducting the test searching at step S140.

Further, not all steps must be performed. By way of non-limiting example, steps S100, S120, S140, and S150 are optional, and any or all may be omitted. No claim herein should be interpreted to include a disclosed step unless specifically recited in such a claim.

Preferably, the web site provider makes the final determination in certain steps. This decision may be made independently of the search engine provider, with the advice of the search engine provider, or subject to a veto of the web service provider (e.g., policing). The recitation in the appended claims of decisions or determinations by the web service provider should not be interpreted to include or exclude such involvement by the search engine provider unless specifically recited therein.

FIG. 4 shows a high-level overview of the structure of the preferred embodiment. Administrator 400 is preferably a staff member of the search engine provider responsible for managing web providers and relationships with external search engines. Web site provider 402 is web provider requesting the indexing process on a company's Web site. External User 404 is a member of the public who is using a search engine to find the sites that match a query.

An indexing rules database 406 includes the rules configured by the web provider and/or the search engine provider defining how the web site is to be crawled, how indexes are to be generated, and how searches are to be processed. Master index database 408 includes specific keywords for specific URLs with criteria for applying them to a search. A usage database 412 includes information about searches performed and click-throughs by external users as well as any payments to or from external search engines. A web provider database includes the privileges for each web provider. Most processes will use this database for authentication purposes.

Processing includes a rules editor that allows the search engine provider or the web site provider to view or adjust the current rules and the way the index was built from the site. The index process builds an index database from the Web site by applying the rules. The search process searches the index database based on a query (depending on the embodiment, this either has a user interface for external users or is directly driven from the external search engines). The usage reporter 414 allows the web site provider and the search engine provider to view usage of the search engine. The web provider management allows the administrator 400 to control the privileges of the web providers.

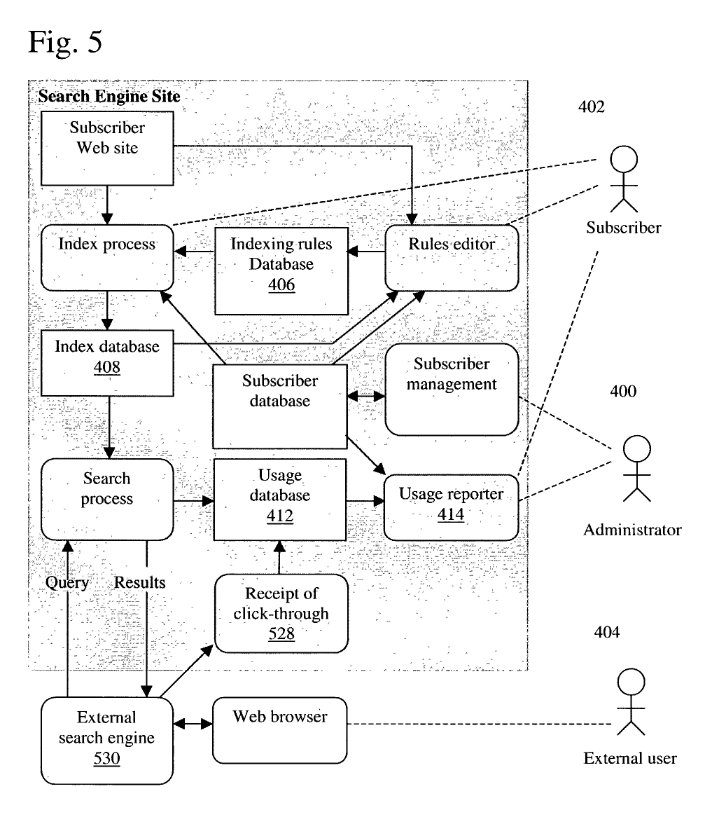

FIG. 5 illustrates an embodiment in which the search engine provider allows external search engines to conduct searches directly on the search engine provider's site. In this embodiment, external search engines may utilize the search engine provider's resources to conduct searches. External search engines so configured typically appear to an end user to be conducting the searches themselves; however, the external search engines are actually using the search engine provider to perform the searches. In operation, a user enters a search criteria into an external search engine, which seamlessly it to the search engine provider's search process. The search engine provider then performs a search. After the search engine provider processes the criteria, it sends the results to the external search engine, and the external search engine presents the results to the end user.

In an alternate version of this embodiment, the external search engine makes it apparent to the end user that it is acting as a conduit through which the search engine provider may be accessed. It is contemplated that “frame within a frame” or “window within a window” techniques may be used to display the search engine provider's services on the web site of the external search engine.

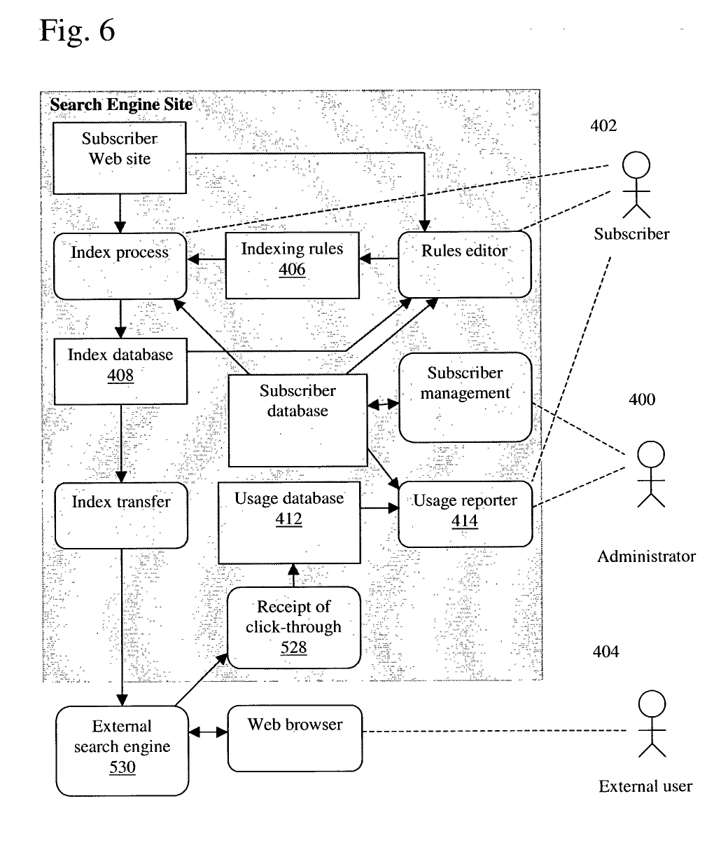

FIG. 6 illustrates an embodiment in which the search engine provider allows external search engines to access the master search index 408 for a search. The external search engine has access to the index and can use the search engine provider's processing tools to search the database. Alternately, the external search engine could use its own processing tools for searching the database. Or the external search engine may receive portions of or the entire master index and process it externally. Similar to the embodiment of FIG. 5, the external search engine in the embodiment of FIG. 6 may or may not make it apparent to the end user that the search engine provider provides resources to the external search engine.

In the embodiments of FIGS. 5 and 6, the “search engine provider” is the entity that performs the search and supplies the results to the external search engine. The external search engine acts as a “front end” to receive user input and display the results.

In the embodiments of FIG. 5 and FIG. 6, the “receipt of click-throughs” 528 processes the click-through data received from the external search engines 530. This information may be used for data gathering, data mining, billing, or other purposes. A usage database 412 receives click-through information from receipt of click-through process 528 and records payments to or from external search engines.

It is noted that the foregoing examples have been provided merely for the purpose of explanation and are in no way to be construed as limiting of the present invention. While the present invention has been described with reference to certain embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed is

1. A method for associating a web site provider with a search engine provider, the web site provider maintaining a web site containing a plurality of web pages and the search engine provider maintaining a master index for use with a search engine for Internet searching, the method comprising:
associating a search criteria with a subset of web pages from the plurality of web pages;
the web provider ranking each web page of the subset of web pages; and
modifying the search engine provider's master index to reflect the search criteria and the association with the subset of web pages;
wherein a search report from a search on the search engine using the search criteria will include the subset of web pages in an order consistent with the rank determined by the web site provider.

2. The method of claim 1, further comprising:
the web service provider selecting the subset of web pages from the plurality of web pages;
wherein the search report will not include any of the plurality of web pages that are not in the subset of web pages.

3. The method of claim 1, further comprising:
receiving the search criteria;
searching the master index based on the search criteria;
providing the search report based on said searching, the search report including the subset of web pages consistent with the rank.

4. The method of claim 3, wherein said providing further comprises one of:
displaying the subset of web pages as a block within the search report;
displaying the subset of web pages at least partially interleaved with other web pages that are also associated with the search criteria; and
displaying the subset of web pages completely interleaved with other web pages that are also associated with the search criteria.

5. The method of claim 1, wherein the search engine is an external search engine.

6. A method for associating a web site provider with a search engine provider, the search engine provider maintaining a master index for use with a search engine for Internet searching, comprising:
automatically searching, under computer control, a web site for terms of interest to add to a temporary index;
using the contents of the temporary index to identify a desired search criteria, said using comprising one of:
selecting at least part of said temporary index;
rejecting said temporary index; and
adding at least one new term to the temporary index;
associating at least one web page with the desired search criteria; and
modifying the search engine provider's master index to reflect the results of said associating;
wherein said using improves searching by limiting the master index to relevant search criteria.

7. The method of claim 6, wherein said automatically searching comprises searching for meta-tags in the web site and words or combinations of words that tend to repeat with a higher frequency than other words or combinations of words in the web site.

8. The method of claim 6, wherein said associating includes testing said master index with the search criteria.

9. The method of claim 6, wherein said using comprises manually using.

10. The method of claim 9, wherein said web site provider performs said using.

11. The method of claim 6, wherein said modifying includes at least one of:
selecting all of the terms of interest as search criteria;
selecting at least some of the terms of interest as search criteria; and
employing at least one new term that did not result from said automatically searching.

12. The method of claim 6, further comprising:
said associating including associating a plurality of web pages with the search criteria; and
a web site provider determining the order in which a plurality of web pages will appear in a search report in response to a search on the search engine using the search criteria;
wherein the search report will include the plurality of web pages in the order determined by the web site provider.

13. The method of claim 6, wherein the search engine is an external search engine.

14. A method for establishing and operating a search engine for Internet searching a plurality of web sites, the method comprising:
a search engine provider working with a web site provider of each of a plurality of web sites to:
mutually decide on a search criteria that will produce a search report that includes at least one web page from the web site; and
modify a master search index to reflect an association between the search criteria and the at least one web page; and
providing, in response to a particular search criteria input to the search engine, all of the associated web pages reflected in the master index associated with the search criteria;
wherein an order in which the associated web pages appear in the search report is independent of any fees paid by the web service providers.

15. The method of claim 14, wherein the order in which the associated web pages from the master index appear in the search report is independent of the content of the associated web pages.

16. The method of claim 14, wherein the order in which the associated web pages from the master index appear in the search report is one of random and pseudorandom.

17. The method of claim 14, further comprising:
producing a global search report, the global search report including:
the results of said providing; and
at least one of the results of an auction-based search and the results of a crawling-based search.

18. The method of claim 14, wherein the search engine is an external search engine.

19. A method for associating a web site provider with a search engine provider, the web site provider maintaining a web site containing a plurality of web pages and the search engine provider maintaining a master index for use with a search engine for Internet searching, the method comprising:
associating at least one web page on the web site with a search criteria;
test searching the master index with the search criteria;
the web site provider determining, based on a result of the test searching, whether the search criteria is one of acceptable and too broad for the at least one web page; and
selecting a different search criteria in response to a determination that the search criteria is too broad, wherein said different search criteria is associated with fewer search results relative to the number of search results associated with the search criteria.

20. The method of claim 19, further comprising repeating said test searching, said determining, and said modifying until said determining determines that the search criteria is acceptable.

21. The method of claim 19, further comprising, between said associating and said test searching, temporarily altering a search engine provider's master index to reflect the association between the search criteria and the at least one web page.

22. The method of claim 19, further comprising, between said associating and said test searching, temporarily altering a search engine provider's master index, contingent upon a condition, to reflect the association between the search criteria and the at least one web page.

23. The method of claim 22 wherein said condition is whether the number of web pages associated with the search criteria is below a predetermined threshold.

24. The method of claim 19, further comprising:
modifying, in response to said determining being acceptable, a search engine provider's master index to reflect the association between the search criteria and the at least one web page; and
a web provider paying a fee to said search engine provider in exchange for said modifying.

25. The method of claim 19, further comprising:
modifying, prior to said determining, a search engine provider's master index to reflect the association between the search criteria and the at least one web page

26. A method for associating a web site provider with a search engine provider, the web site provider maintaining a web site containing a plurality of web pages and the search engine provider maintaining a master index for use with a search engine for Internet searching, the method comprising:
associating at least one web page on the web site with a search criteria;
test searching the master index with the search criteria to determine the number of associated web pages in the master index;
determining, based at least on the number, whether the search criteria is too broad for the at least one web page; and
altering the search criteria to produce an altered search criteria, wherein the altered search criteria has less associated web pages in the master index than the unaltered criteria.

27. The method of claim 26, further comprising repeating said test searching, said determining, and said modifying until said determining determines that the search criteria is not too broad for the at least one web page.

28. The method of claim 26, further comprising, between said associating and said test searching, temporarily altering a search engine provider's master index, contingent upon a condition, to reflect the association between the search criteria and the at least one web page.

29. The method of claim 28, wherein the condition is whether the number of web pages associated with the search criteria is below a predetermined threshold.

30. The method of claim 26, wherein if said determining determines that the search criteria is acceptable, said method further comprising:
altering a search engine provider's master index to reflect the association between the search criteria and the at least one web page; and
a web provider paying a fee to said search engine provider in exchange for said modifying.

31. The method of claim 26, wherein the search engine is an external search engine.
